(19) United States
(12) Patent Application Publication
(10) Pub. No.: US 2022/0080994 A1
(43) Pub. Date: Mar. 17, 2022

(54) VEHICLE CONTROL SYSTEM

(71) Applicant: TOYOTA JIDOSHA KABUSHIKI KAISHA, Toyota-shi (JP)

(72) Inventor: Miki NOMOTO, Nisshin-shi (JP)

(73) Assignee: TOYOTA JIDOSHA KABUSHIKI KAISHA, Toyota-shi (JP)

(21) Appl. No.: 17/383,514

(22) Filed: Jul. 23, 2021

(30) Foreign Application Priority Data
Sep. 17, 2020 (JP) 2020-156211

(51) Int. Cl. B60W 50/12; B60W 50/14; B60W 60/00; G05D 1/00

(52) U.S. Cl. CPC B60W 50/12; B60W 50/14; B60W 60/005; B60W 2050/146; B60W 2510/1005; B60W 2050/143; G05D 1/0088

(57) ABSTRACT

A vehicle control system controls a vehicle equipped with a gearshift. The vehicle control system includes: one or more processors configured to execute automated driving control of the vehicle; and a notification device configured to notify an operator of the vehicle of information. The one or more processors determine whether or not a first gear position being a gear position required in the automated driving control and a second gear position being a gear position specified by the gearshift are consistent with each other. When the first gear position and the second gear position are not consistent with each other during execution of the automated driving control, the one or more processors notify through the notification device first information at least indicating that a current gear position is the first gear position.

### BACKGROUND

### Technical Field

The present disclosure relates to a vehicle control system that executes an automated driving control of a vehicle.

### Background Art

Patent Literature 1 discloses a driving assist device. The driving assist device includes a gear position detecting means for detecting a position of a gear operation member, and a display means for displaying a mark corresponding to a current position of the gear operation member. The driving assist device further includes a notifying means that, when the position of the gear operation member is changed, notifies a driver thereof by temporarily changing a display state of the mark displayed on the display means.

### List of Related Art

Patent Literature 1: Japanese Laid-Open Patent Application Publication No. JP-2014-129025

### SUMMARY

In automated driving control of a vehicle, a gear position is switched by the use of a shift-by-wire technology. Meanwhile, there is also a vehicle equipped with a gearshift (shift lever) operated by an operator of the vehicle. Regarding a situation where the automated driving control of such the vehicle equipped with the gearshift is performed, the inventor of the present application has recognized the following problem. That is, when a gear position requested by the automated driving control and a gear position specified by the gearshift are different from each other, the operator may erroneously recognize a current gear position.

An object of the present disclosure is to provide a technique that can suppress an operator of a vehicle equipped with a gearshift from erroneously recognizing a current gear position in a situation where automated driving control of the vehicle is performed.

In an aspect of the present disclosure, a vehicle control system that controls a vehicle equipped with a gearshift is provided.

The vehicle control system includes:

one or more processors configured to execute automated driving control of the vehicle; and

a notification device configured to notify an operator of the vehicle of information.

The one or more processors determine whether or not a first gear position being a gear position required in the automated driving control and a second gear position being a gear position specified by the gearshift are consistent with each other.

When the first gear position and the second gear position are not consistent with each other during execution of the automated driving control, the one or more processors notify through the notification device first information at least indicating that a current gear position is the first gear position.

According to the present disclosure, when the first gear position and the second gear position are not consistent with each other during execution of the automated driving control, the operator is notified of the first information at least indicating that “the current gear position is the first gear position.” As a result, it is suppressed that the operator erroneously recognizes the current gear position (i.e., a control direction by the automated driving control). By accurately recognizing control intent of the automated driving control, the operator is able to rightly judge whether or not an override is necessary.

### BRIEF DESCRIPTION OF DRAWINGS

FIG. 1 is a block diagram showing a configuration example of a vehicle and a vehicle control system according to an embodiment of the present disclosure;

FIG. 2 is a block diagram showing an example of a functional configuration related to automated driving control according to an embodiment of the present disclosure;

FIG. 3 is a block diagram for explaining an example of a functional configuration related to a gear position mediation process according to an embodiment of the present disclosure;

FIG. 4 is a block diagram showing an example of a functional configuration related to an information notification process according to an embodiment of the present disclosure;

FIG. 5 is a flow chart showing a first example of the information notification process according to an embodiment of the present disclosure;

FIG. 6 is a conceptual diagram for explaining the first example of the information notification process according to an embodiment of the present disclosure;

FIG. 7 is a conceptual diagram for explaining the first example of the information notification process according to an embodiment of the present disclosure;

FIG. 8 is a flow chart showing a second example of the information notification process according to an embodiment of the present disclosure;

FIG. 9 is a conceptual diagram for explaining the second example of the information notification process according to an embodiment of the present disclosure;

FIG. 10 is a flow chart showing a third example of the information notification process according to an embodiment of the present disclosure;

FIG. 11 is a conceptual diagram for explaining the third example of the information notification process according to an embodiment of the present disclosure;

FIG. 12 is a flow chart showing a fourth example of the information notification process according to an embodiment of the present disclosure; and

FIG. 13 is a conceptual diagram for explaining a fifth example of the information notification process according to an embodiment of the present disclosure.

### EMBODIMENTS

Embodiments of the present disclosure will be described with reference to the accompanying drawings.

### 1. Vehicle and Vehicle Control System

### 1-1. Configuration Example

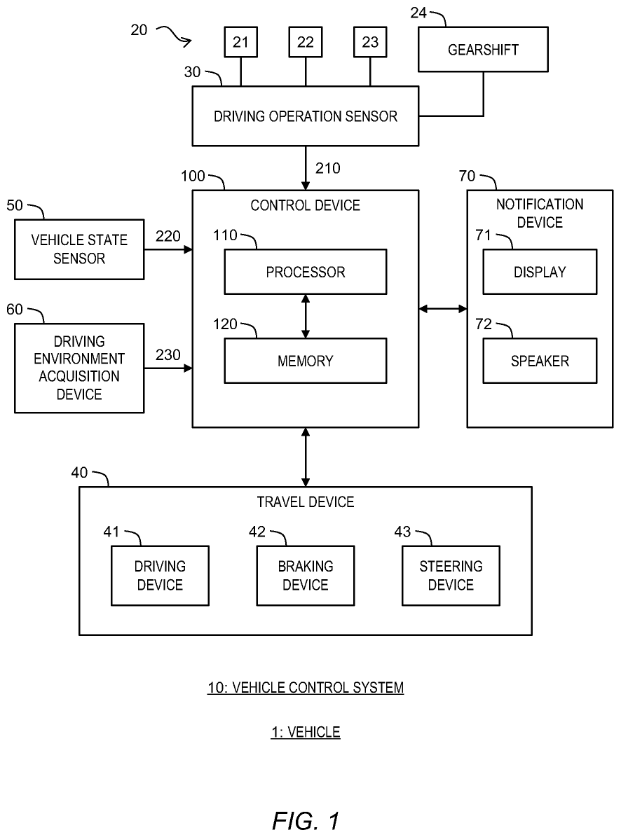

FIG. 1 is a block diagram showing a configuration example of a vehicle 1 and a vehicle control system 10 according to the present embodiment. The vehicle 1 includes a driving operation member 20, a driving operation sensor 30, a travel device 40, a vehicle state sensor 50, and a driving environment acquisition device 60.

The driving operation member 20 is a member that is operated by an operator (driver) of the vehicle 1 when driving the vehicle 1. The driving operation member 20 includes an accelerator pedal 21, a brake pedal 22, a steering wheel 23, and a gearshift 24.

The gearshift (shift lever) 24 is used for switching a gear position by the operator. The gearshift 24 may be a “gate type” or a “straight type”. The operator is able to switch and select the gear position by moving the gearshift 24. The gear positions include “P (Parking)”, “R (Reverse)”, “N (Neutral)”, “D (Drive)”, “2 (Second)”, “L (Low)”, and the like.

The driving operation sensor 30 detects a driving operation performed by the operator. The driving operations include an acceleration operation, a braking operation, a steering operation, and a gearshift operation. The driving operation sensor 30 includes an accelerator pedal sensor, a brake sensor, a steering angle sensor, a steering torque sensor, a gear position sensor, and the like. The accelerator pedal sensor detects a stroke amount of the accelerator pedal 21. The brake sensor detects a stroke amount of the brake pedal 22. The steering angle sensor detects a steering angle. The steering torque sensor detects a steering torque. The gear position sensor detects the position of the gearshift 24. The driving operation sensor 30 outputs driving operation information 210 indicating the detection result.

The travel device 40 includes a driving device 41, a braking device 42, and a steering device 43. The driving device 41 generates a driving force for driving the vehicle 1. Typically, the driving device 41 includes a powertrain. The powertrain includes at least one of an engine and a motor, a transmission, and the like. Switching of the gear position is performed by utilizing a shift-by-wire technology. As another example, the driving device 41 may be constituted by an in-wheel motor provided on each wheel. The braking device 42 generates a braking force. The steering device 43 steers wheels of the vehicle 1. For example, the steering device 43 includes an electric power steering (EPS) device.

The vehicle state sensor 50 detects a state of the vehicle 1. For example, the vehicle state sensor 50 includes a wheel speed sensor, a vehicle speed sensor, an acceleration sensor, a yaw rate sensor, and the like. The vehicle state sensor 50 outputs vehicle state information 220 indicating the detected state of the vehicle 1.

The driving environment acquiring device 60 acquires driving environment information 230 indicating a driving environment for the vehicle 1. The driving environment information 230 includes map information, vehicle position information indicating a position of the vehicle 1, surrounding situation information indicating a situation around the vehicle 1, and the like. For example, the driving environment acquisition device 60 acquires the vehicle position information by the use of a GPS (Global Positioning System) sensor. Further, the driving environment acquiring device 60 acquires the surrounding situation information by the use of a recognition sensor. Examples of the recognition sensor include a cameras, a radar, a LIDAR (Laser Imaging Detection and Ranging), and the like.

The vehicle control system 10 controls the vehicle 1. Typically, the vehicle control system 10 is installed on the vehicle 1. Alternatively, at least a part of the vehicle control system 10 may be located outside the vehicle 1 and remotely perform vehicle control. The vehicle control system 10 includes at least a control device (controller) 100 and a notification device 70. The vehicle control system 10 may further include the driving operation sensor 30, the travel device 40, the vehicle state sensor 50, and the driving environment acquisition device 60.

The notification device 70 notifies the operator of the vehicle 1 of information. The notification device 70 includes a display 71. Examples of the display 71 include a monitor, a touch panel, an HUD (Head-Up Display), and the like. The notification device 70 may include a speaker 72. The notification device 70 may be included in an HMI (Human-Machine Interface) installed on the vehicle 1. Alternatively, the notification device 70 may be a terminal device such as a tablet and a smartphone.

The control device (controller) 100 controls the vehicle 1. The control device 100 includes one or more processors 110 (hereinafter simply referred to as a processor 110) and one or more memories 120 (hereinafter simply referred to as a memory 120). The processor 110 executes a variety of processing. For example, processor 110 includes a CPU (Central Processing Unit). The memory 120 stores a variety of information. Examples of the memory 120 include a volatile memory, a non-volatile memory, an HDD (Hard Disk Drive), an SSD (Solid State Drive), and the like. The variety of processing by the processor 110 (the control device 100) is implemented by the processor 110 executing a control program being a computer program. The control program is stored in the memory 120 or recorded on a computer readable recording medium. The control device 100 may include one or more ECUs (Electronic Control Unit). A part of the control device 100 may be an information processing device outside the vehicle 1. In that case, the part of the control device 100 communicates with the vehicle 1 and remotely controls the vehicle 1.

### 1-2. Processing by Control Device 100 (Processor 110)

The control device 100 acquires the driving operation information 210, the vehicle state information 220, and the driving environment information 230 from the driving operation sensor 30, the vehicle state sensor 50, and the driving environment acquisition device 60, respectively. The driving operation information 210, the vehicle state information 220, and the driving environment information 230 are stored in the memory 120.

The control device 100 executes vehicle travel control that controls travel of the vehicle 1. The vehicle travel control includes acceleration control, gear position control, deceleration control, and steering control. The control device 100 executes the acceleration control and the gear position control by controlling the driving device 41. The control device 100 executes the deceleration control by controlling the braking device 42. The control device 100 executes the steering control by controlling the steering device 43. In the vehicle travel control, the vehicle state information 220 (the vehicle speed, the acceleration, the steering angle, the steering torque, and the like) is used.

Furthermore, the control device 100 has a function of executing automated driving control of the vehicle 1. The automated driving supposed here is one where the operator may not necessarily 100% concentrate on the driving (e.g., so-called Level 3 or higher level automated driving).

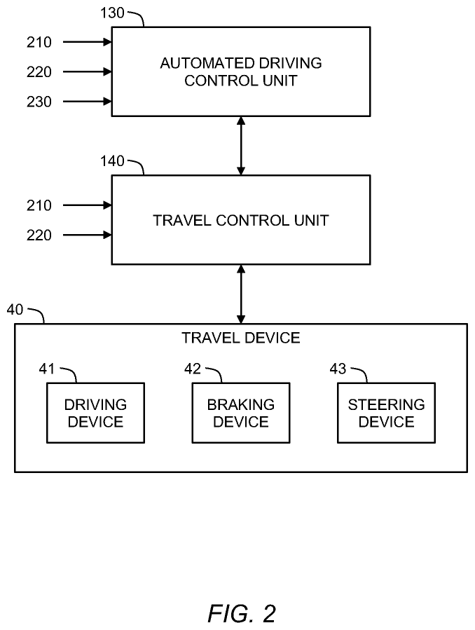

FIG. 2 is a block diagram showing an example of a functional configuration related to the automated driving control. The control device 100 includes an automated driving control unit 130 and a travel control unit 140.

The automated driving control unit 130 controls the automated driving of the vehicle 1. More specifically, the automated driving control unit 130 generates a travel plan of the vehicle 1 during the automated driving, based on the vehicle state information 220 and the driving environment information 230. Examples of the travel plan include keeping a current travel lane, making a lane change, avoiding an obstacle, and the like. Then, the automated driving control unit 130 generates each of an acceleration request, a deceleration request, a steering request, and a gear position request necessary for the vehicle 1 to travel in accordance with the travel plan. For example, the automated driving control unit 130 generates a target trajectory necessary for the vehicle 1 to travel in accordance with the travel plan. The target trajectory includes a target position and a target speed of the vehicle 1 in a road in which the vehicle 1 travels. Then, the automated driving control unit 130 generates each of the acceleration request, the deceleration request, the steering request, and the gear position request necessary for the vehicle 1 to follow the target trajectory. The automated driving control unit 130 outputs each of the acceleration request, the deceleration request, the steering request, and the gear position request to the travel control unit 140.

The travel control unit 140 executes the above-described vehicle travel control in accordance with each of the acceleration request, the deceleration request, the steering request, and the gear position request from the automated driving control unit 130. That is, the travel control unit 140 executes the acceleration control and the gear position control by controlling the driving device 41 in accordance with the acceleration request and the gear position request. The control device 100 executes the deceleration control by controlling the braking device 42 in accordance with the deceleration request. The control device 100 executes the steering control by controlling the steering device 43 in accordance with the steering request. In the vehicle travel control, the vehicle state information 220 (the vehicle speed, the acceleration, the steering angle, the steering torque, and the like) is used. In this manner, the automated driving control of the vehicle 1 is implemented.

The automated driving control unit 130 and the travel control unit 140 are implemented by the one or more processors 110 and the one or more memories 120. The automated driving control unit 130 and the travel control unit 140 may be implemented by separate ECUs. The automated driving control unit 130 and the travel control unit 140 may be implemented by a same ECU. As yet another example, the automated driving control unit 130 may be provided as an automated driving kit. That is, the automated driving control unit 130 may be implemented by an automated driving kit that is additionally installed to an existing vehicle 1.

### 1-3. Override

During execution of the automated driving control, the operator of the vehicle 1 can override (intervene in) the automated driving control as necessary. Typically, the operator performs the override by operating the driving operation member 20. For example, the operator is able to override by stepping on the brake pedal 22. As another example, the operator is able to override by steering the steering wheel 23.

The control device 100 (the automated driving control unit 130, the travel control unit 140) is able to recognize the override operation by the operator based on the driving operation information 210. Upon recognizing the override operation, the control device 100 performs a transition from the automated driving control to manual driving. In the case of the manual driving, the control device 100 (the travel control unit 140) executes the above-described vehicle travel control in accordance with the driving operation performed by the operator. That is, the control device (the travel control unit 140) executes the above-described vehicle travel control in accordance with the driving operation indicated by the driving operation information 210.

### 1-4. Gear Position Mediation Process

As described above, the vehicle 1 according to the present embodiment is equipped with the gearshift 24. The operator is able to switch and select the gear position by moving the gearshift 24. Meanwhile, during execution of the automated driving control, the gear position is determined by the automated driving control unit 130. The control device 100 executes a “gear position mediation process” that selects the gear position according to whether a driving mode is the manual driving or automated driving.

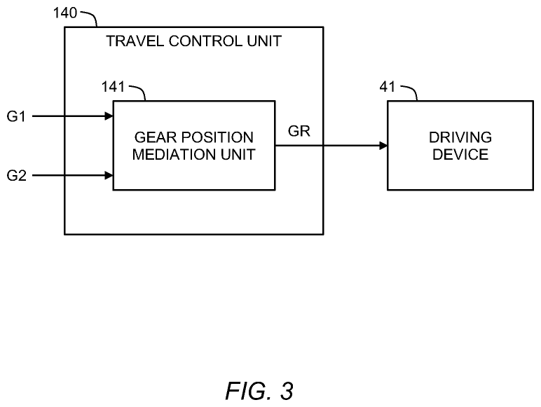

FIG. 3 is a block diagram for explaining an example of a functional configuration related to the gear position mediation process. The gear position required in the automated driving control, that is, the gear position determined by the automated driving control unit 130 is hereinafter referred to as a “first gear position G1.” On the other hand, the gear position specified by the gearshift 24 is hereinafter referred to as a “second gear position G2.” Moreover, the gear position used for the control of the driving device 41 is hereinafter referred to as a “requested gear position GR.”

The travel control unit 140 includes a gear position mediation unit 141. The gear position mediation unit 141 receives information on the first gear position G1 from the automated driving control unit 130. Moreover, the gear position mediation unit 141 acquires information on the second gear position G2 from the driving operation information 210. During execution of the automated driving control, the gear position mediation unit 141 selects the first gear position G1 as the requested gear position GR. On the other hand, during the manual driving, the gear position mediation unit 141 selects the second gear position G2 as the requested gear position GR.

The travel control unit 140 controls the driving device 41 to drive the vehicle 1 at the requested gear position GR. For example, when the driving device 41 includes a shift-by-wire actuator, the travel control unit 140 controls the shift-by-wire actuator such that the vehicle 1 is driven at the requested gear position GR. During execution of the automated driving control, the travel control unit 140 controls the driving device 41 to drive the vehicle 1 at the first gear position G1. On the other hand, during the manual driving, the travel control unit 140 controls the driving device 41 to drive the vehicle 1 at the second gear position G2.

### 2. Information Notification Process

The control device 100 according to the present embodiment further executes an “information notification process” that notifies the operator of the vehicle 1 of information. In the information notification process, the notification device 70 described above is used. That is, the control device 100 notifies the operator of necessary information through the notification device 70. In the present embodiment, notifying the operator of “information related to the gear position” is considered in particular.

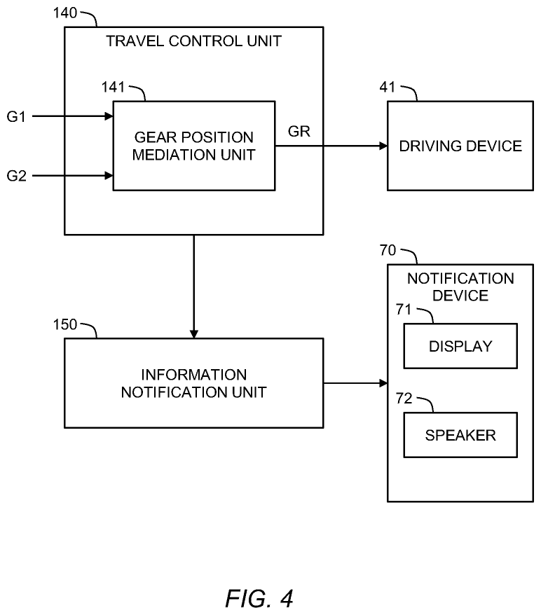

FIG. 4 is a block diagram showing an example of a functional configuration related to the information notification process according to the present embodiment. The control device 100 includes an information notification unit 150. The information notification unit 150 receives the “information related to the gear position” from the travel control unit 140. Various examples of the information related to gear position will be described later. Then, the information notification unit 150 notifies the operator of the information related to the gear position through the notification device 70. In other words, the information notification unit 150 controls the notification device 70 to notify the information related to the gear position. Visual information is displayed on the display 71 to be notified to the operator. Speech information is output from the speaker 72 to be notified to the operator.

The information notification unit 150 is implemented by the one or more processors 110 and the one or more memories 120. The information notification unit 150 may be included in the automated driving control unit 130. In that case, the information related to the gear position is sent from the travel control unit 140 to the automated driving control unit 130. Then, the automated driving control unit 130 notifies the operator of the information related to the gear position through the notification device 70.

Hereinafter, various examples of the information notification process according to the present embodiment will be described.

### 2-1. First Example

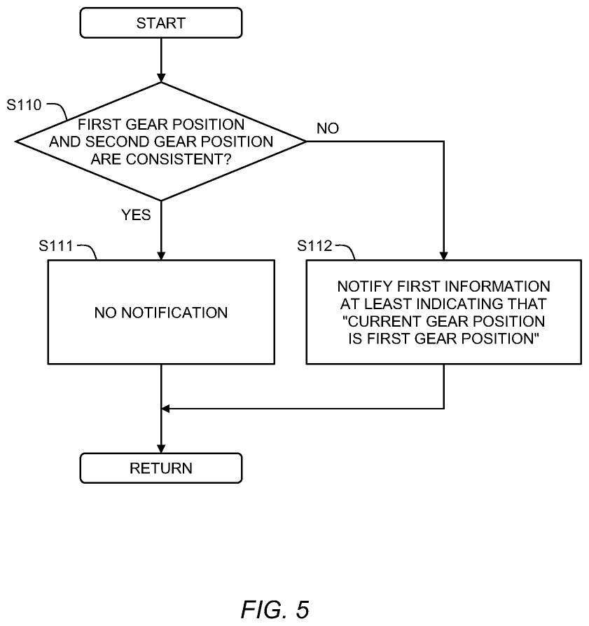

FIG. 5 is a flow chart showing a first example of the information notification process according to the present embodiment. Here, a situation where the automated driving control is in execution is considered.

In Step S110, the control device 100 (i.e., the travel control unit 140) determines whether or not the first gear position G1 and the second gear position G2 are consistent with each other. Here, “the first gear position G1 and the second gear position G2 being consistent with each other” means that a travel direction of the vehicle 1 expected from the first gear position G1 and a travel direction of the vehicle 1 expected from the second gear position G2 are consistent with each other. Conversely, “the first gear position G1 and the second gear position G2 being not consistent with each other” means that the travel direction of the vehicle 1 expected from the first gear position G1 and a travel direction of the vehicle 1 expected from the second gear position G2 are not consistent with each other. The travel direction expected from each of the gear positions “D”, “2”, and “L” is “forward.” The travel direction expected from the gear position “R” is “backward.” The travel direction expected from each of the gear positions “N” and “P” is “stop.” For example, the gear position “D” is consistent with each of the gear positions “D,” “2”, and “L” and is not consistent with each of the gear positions “R”, “N”, and “P.” The gear position “R” is consistent only with the gear position “R” and is not consistent with the other gear positions.

When the first gear position G1 and the second gear position G2 are consistent with each other (Step S110; Yes), the control device 100 (i.e., the information notification unit 150) notifies nothing in particular (Step S111). That is, the control device 100 dare refrains from notifying that the first gear position G1 and the second gear position G2 are consistent with each other.

On the other hand, when the first gear position G1 and the second gear position G2 are not consistent with each other (Step S110; No), the processing proceeds to Step S112. When the first gear position G1 and the second gear position G2 are not consistent with each other, the operator may erroneously recognize a current gear position (i.e., a control direction by the automated driving control). In addition, the operator may be confused about the current gear position (i.e., the control direction by the automated driving control). Therefore, in order to suppress the operator's erroneous recognition and the operator's confusion, the control device 100 (i.e., the information notification unit 150) notifies through the notification device 70 information at least indicating that “the current gear position is the first gear position G1.” This information is hereinafter referred to as “first information.”

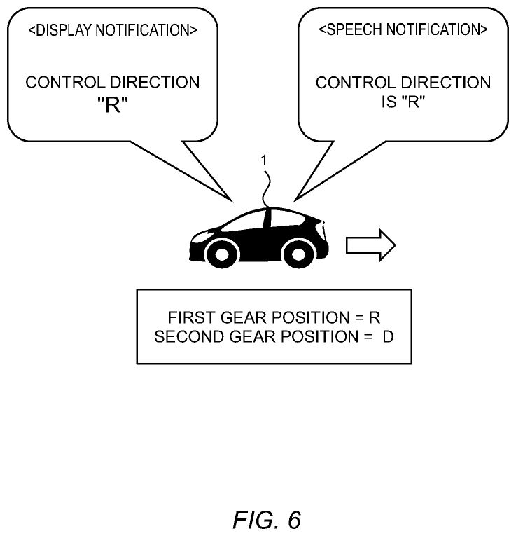

FIG. 6 is a conceptual diagram for explaining an example of the first information. In the present example, the first gear position G1 is “R”, the second gear position G2 is “D”, and both gear positions are not consistent with each other. In this case, the operator is notified of information that “the current gear position (control direction) is R.” The notification includes at least one of a display notification through the display 71 and a speech notification through the speaker 72.

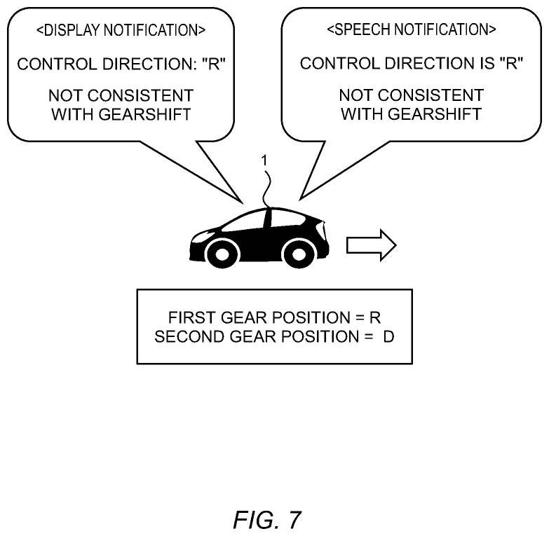

FIG. 7 is a conceptual diagram for explaining another example of the first information. In this example, the first information further indicates that “the first gear position G1 and the second gear position G2 are not consistent with each other”, in addition to the information shown in the above FIG. 6. The first information may indicate both the first gear position G1 and the second gear position G2.

As described above, according to the first example of the information notification process, when the first gear position G1 and the second gear position G2 are not consistent with each other during execution of the automated driving control, the first information at least indicating that “the current gear position is the first gear position G1” is notified. As a result, it is suppressed that the operator of the vehicle 1 erroneously recognizes the current gear position (i.e., the control direction by the automated driving control). In addition, the operator's confusion also is suppressed.

Moreover, by accurately recognizing the control direction (control intent) of the automated driving control, the operator of the vehicle 1 is able to rightly judge whether or not the override is necessary.

Furthermore, according to the first example of the information notification process, when the first gear position G1 and the second gear position G2 are consistent with each other during execution of the automated driving control, no particular notification is given. That is, the “gear position consistency state” is not notified in particular. As a result, the “gear position inconsistency state” is relatively emphasized. That is, the operator is able to notice the gear position inconsistency state more easily. Thus, the operator's erroneous recognition and the operator's confusion are suppressed more effectively.

### 2-2. Second Example

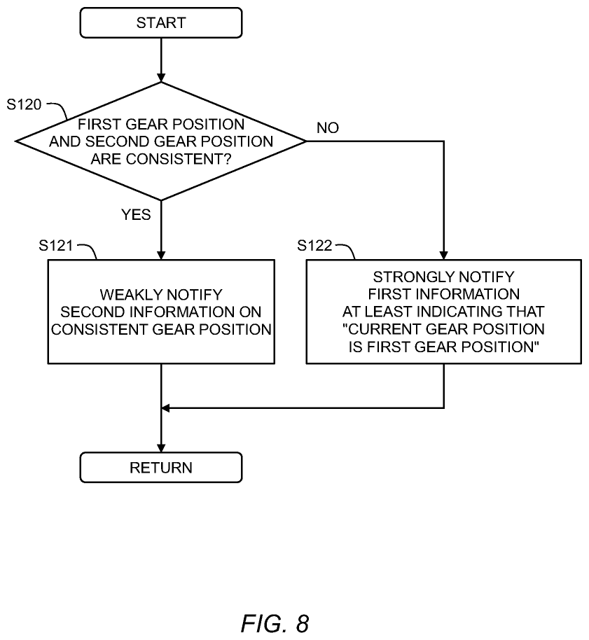

FIG. 8 is a flow chart showing a second example of the information notification process according to the present embodiment. The second example is a modification example of the first example.

In Step S120, the control device 100 (i.e., the travel control unit 140) determines whether or not the first gear position G1 and the second gear position G2 are consistent with each other. This Step S120 is similar to Step S110 described above.

When the first gear position G1 and the second gear position G2 are consistent with each other (Step S120; Yes), the processing proceeds to Step S121. In Step S121, the control device 100 (i.e., the information notification unit 150) notifies information regarding the consistent gear position through the notification device 70. This information is hereinafter referred to as “second information.” For example, the second information indicates that the current gear position is the first gear position G1 (=the second gear position G2). As another example, the second information may indicate that the first gear position G1 and the second gear position G2 are consistent with each other.

On the other hand, when the first gear position G1 and the second gear position G2 are not consistent with each other (Step S120; No), the processing proceeds to Step S122. In Step S122, the control device 100 (i.e., the information notification unit 150) notifies the above-described first information through the notification device 70. At this time, the control device 100 (i.e., the information notification unit 150) sets a notification intensity of the first information higher than a notification intensity of the second information. Here, the notification intensity of the information displayed on the display 71 includes at least one of a character size, a character weight, brightness, and saturation. The notification intensity of the information output from the speaker 72 is sound volume.

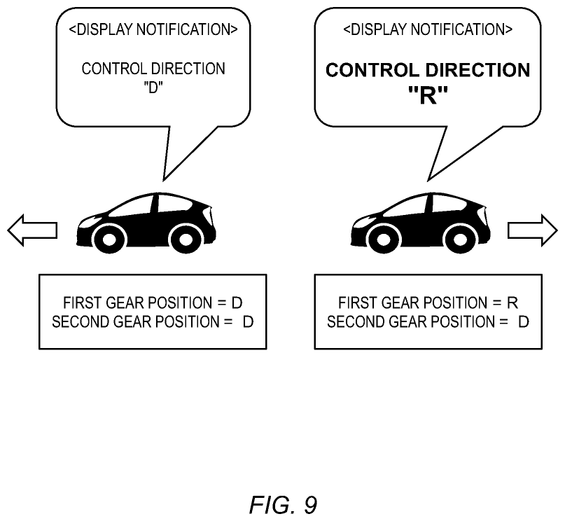

FIG. 9 shows an example of contrast between the first information and the second information. When the first gear position G1 and the second gear position G2 are the same “D”, the second information indicating that “the current gear position (the control direction) is D” is notified by relatively small characters. On the other hand, when the first gear position G1 is “R” and the second gear position G2 is “D”, the first information indicating that “the current gear position (the control direction) is R” is notified by relatively bold and large characters.

As described above, according to the second example of the information notification process, the notification intensity of the first information when the first gear position G1 and the second gear position G2 are not consistent with each other is higher than the notification intensity of the second information when both are consistent with each other. As a result, the same effects as in the case of the first example described above can be obtained. That is, the gear position inconsistency state is relatively emphasized, and the operator is able to notice the gear position inconsistency state more easily. Thus, the operator's erroneous recognition and the operator's confusion are suppressed more effectively.

### 2-3. Third Example

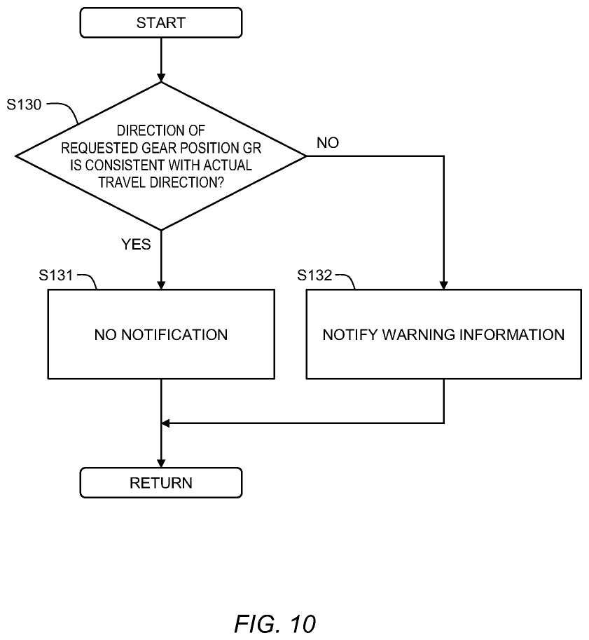

FIG. 10 is a flow chart showing a third example of the information notification process according to the present embodiment.

In Step S130, the control device 100 (i.e., the travel control unit 140) determines whether or not a travel direction of the vehicle 1 expected from the requested gear position GR is consistent with an actual travel direction. As described above, during execution of the automated driving control, the requested gear position GR is the first gear position G1 that is determined by the automated driving control unit 130. On the other hand, during the manual driving, the requested gear position GR is the second gear position G2 that is specified by the gearshift 24. The actual travel direction of the vehicle 1 is detected, for example, by the wheel speed sensor included in the vehicle state sensor 50. The control device 100 is able to recognize the actual travel direction of the vehicle 1 based on the vehicle state information 220.

When the travel direction expected from the requested gear position GR is consistent with the actual travel direction (Step S130; Yes), the control device 100 (i.e., the information notification unit 150) notifies nothing in particular (Step S131).

On the other hand, when the travel direction expected from the requested gear position GR is not consistent with the actual travel direction (Step S130; No), the processing proceeds to Step S132. The fact that the travel direction expected from the requested gear position GR is not consistent with the actual travel direction means that the vehicle 1 is not being driven as intended. Therefore, the control device 100 (i.e., the information notification unit 150) notifies the operator of warning information through the notification device 70 in order to invite the operator's attention. The warning information may urge the operator to perform the braking operation.

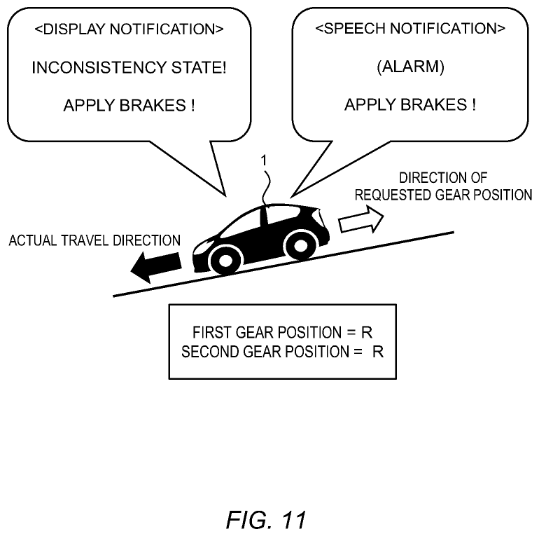

FIG. 11 is a conceptual diagram for explaining an example of the warning information. The vehicle 1 is located on a downhill. The automated driving control is in execution and the requested gear position GR (i.e., the first gear position G1) is “R.” The travel direction expected from the requested gear position GR is “backward.” However, if a required driving force determined by the automated driving control unit 130 is not sufficient, the vehicle 1 moves forward. In this case, the warning information is notified in order to invite the operator's attention. For example, the warning information such as “inconsistency state” and “apply brakes” is notified. In response to the warning information, the operator can push the brake pedal 22 to stop the vehicle 1.

As described above, according to the third example of the information notification process, when the travel direction expected from the requested gear position GR is not consistent with the actual travel direction, the operator of the vehicle 1 is notified of the warning information. This enables the operator to recognize that the vehicle 1 is in a high risk scene and to take an appropriate action. For example, the operator can perform the braking operation or override.

### 2-4. Fourth Example

In a fourth example, a case where the automated driving control unit 130 issues a gear change request (that is, a request for change in the first gear position G1) during execution of the automated driving control is considered. The “gear change” here means a gear change where the travel direction of the vehicle 1 is changed (e.g., change from “D” to “R”).

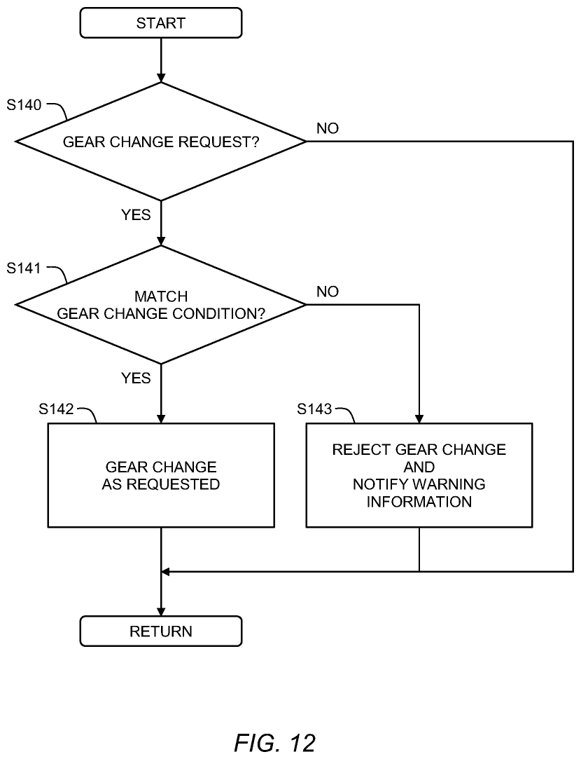

FIG. 12 is a flow chart showing the fourth example of the information notification process according to the present embodiment.

In Step S140, the control device 100 determines whether or not the gear change request is issued. In other words, the control device 100 (i.e., the travel control unit 140) determines whether or not a change in the first gear position G1 is requested by the automated driving control unit 130. When a change in the first gear position G1 is requested (Step S140; Yes), the processing proceeds to Step S141.

In Step S141, the control device 100 (the travel control unit 140) determines whether or not the gear change request matches a gear change condition. For example, the gear change condition is that “the vehicle 1 is stopped.” The gear change request issued in a state where the vehicle 1 is not stopped does not match the gear change condition. As another example, the gear change condition is that “the automated driving control unit 130 issues a deceleration request together with the gear change request.” When the gear change request matches the gear change condition (Step S141; Yes), the processing proceeds to Step S142. On the other hand, when the gear change request does not match the gear change condition (Step S141; No), the processing proceeds to Step S143.

In Step S142, the control device 100 (i.e., the travel control unit 140) changes the first gear position G1 according to the gear change request.

In Step S143, the control device 100 (i.e., the travel control unit 140) rejects the change in the first gear position G1. Further, the control device 100 (i.e., the information notification unit 150) notifies the operator of the warning information through the notification device 70 in order to invite the operator's attention. The warning information may include a reason for rejecting the gear change request.

As described above, according to the fourth example of the information notification process, when the gear change request issued during the automated driving control does not match the gear change condition, the operator of the vehicle 1 is notified of the warning information. This enables the operator to recognize malfunction of the automated driving control and to to take an appropriate action. For example, the operator can perform the braking operation or override.

### 2-5. Fifth Example

As long as there is no contradiction, it is also possible to combine two or more of the first to fourth examples described above.

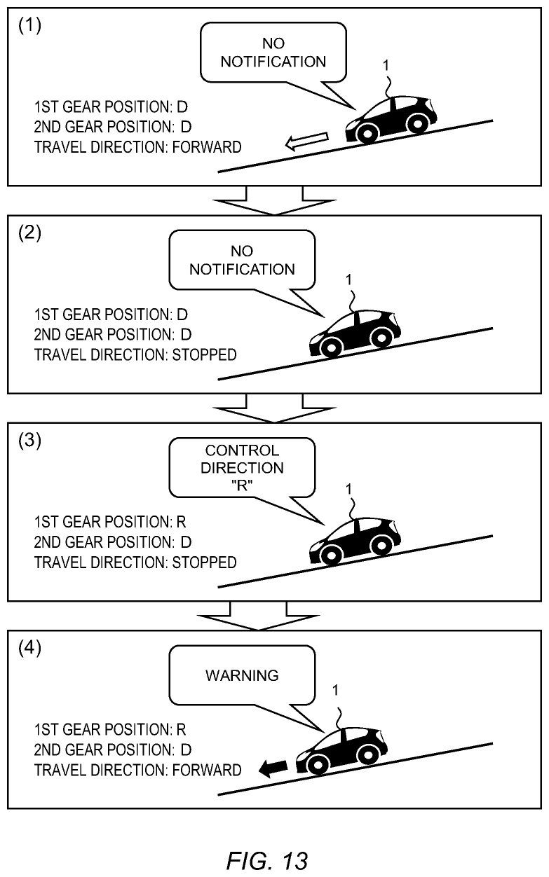

FIG. 13 is a conceptual diagram for explaining an example of the information notification process. The vehicle 1 under the automated driving control is located on a downhill. The second gear position G2 specified by the gearshift 24 is “D.”

In a state (1) shown in FIG. 13, the first gear position G1 is “D.” Since the first gear position G1 and the second gear position G2 are consistent with each other, no notification is performed (Step S111).

In a subsequent state (2), the automated driving control unit 130 issues a deceleration request and thus the vehicle 1 stops.

In a subsequent state (3), the automated driving control unit 130 issues a gear change request for changing the first gear position G1 from “D” to “R.” Since the vehicle 1 is stopped, the gear change request matches the gear change condition (Step S141; Yes). Therefore, the control device 100 changes the first gear position G1 from “D” to “R” in accordance with the gear change request (Step S142). As a result, the first gear position G1 and the second gear position G2 are not consistent with each other, and thus the control device 100 (i.e., the information notification unit 150) notifies that the current gear position (the control direction) is “R” (Step S112, FIG. 5).

In a subsequent state (4), the automated driving control unit 130 issues an acceleration request. However, the acceleration is insufficient, and the vehicle 1 does not move backward but forward. Since the travel direction expected from the requested gear position GR (=“R”) is not consistent with the actual travel direction, the warning information is notified (Step S132, FIG. 10).

### 3. Demonstration of Automated Driving

Demonstration of Level 4 automated driving is usually conducted under the supervision of a safety driver. That is, the demonstration of the automated driving is conducted with the safety driver sitting on a driver's seat of a vehicle. In a case where the vehicle is equipped with the gearshift 24, the information notification process according to the present embodiment is useful.

Applying the present embodiment makes is possible to suppress that the safety driver erroneously recognizes the current gear position (i.e., the control direction by the automated driving control). In addition, the safety driver's confusion also is suppressed. Moreover, the safety driver is able to rightly determine whether or not the override is necessary. That is to say, even in the case of the vehicle equipped with the gearshift 24, it is possible to safely conduct the automated driving demonstration. This increases the number of types of vehicles that can be used for the automated driving demonstration. For example, it is possible to select a smaller vehicle or a less expensive vehicle than ever before.

What is claimed is:

1. A vehicle control system that controls a vehicle equipped with a gearshift, the vehicle control system comprising:
one or more processors configured to execute automated driving control of the vehicle; and
a notification device configured to notify an operator of the vehicle of information, wherein
the one or more processors are further configured to:
determine whether or not a first gear position being a gear position required in the automated driving control and a second gear position being a gear position specified by the gearshift are consistent with each other; and
when the first gear position and the second gear position are not consistent with each other during execution of the automated driving control, notify through the notification device first information at least indicating that a current gear position is the first gear position.

2. The vehicle control system according to claim 1, wherein
the first information further indicates that the first gear position and the second gear position are not consistent with each other.

3. The vehicle control system according to claim 1, wherein
when the first gear position and the second gear position are consistent with each other during execution of the automated driving control, the one or more processors refrain from notifying that the first gear position and the second gear position are consistent with each other.

4. The vehicle control system according to claim 1, wherein
when the first gear position and the second gear position are consistent with each other during execution of the automated driving control, the one or more processors notify through the notification device second information indicating that the current gear position is the first gear position or indicating that the first gear position and the second gear position are consistent with each other,
a notification intensity of the information includes at least one of a character size, a character weight, brightness, saturation, and sound volume, and
the one or more processors set the notification intensity of the first information higher than the notification intensity of the second information.

5. The vehicle control system according to claim 1, wherein
during execution of the automated driving control, the one or more processors control a driving device of the vehicle to drive the vehicle at the first gear position, and
during manual driving, the one or more processors control the driving device to drive the vehicle at the second gear position.

6. The vehicle control system according to claim 5, wherein
when a travel direction of the vehicle expected from the first gear position during execution of the automated driving control is not consistent with an actual travel direction, the one or more processors notify warning information through the notification device.

7. The vehicle control system according to claim 5, wherein
when a travel direction of the vehicle expected from the second gear position during the manual driving is not consistent with an actual travel direction, the one or more processors notify warning information through the notification device.

8. The vehicle control system according to claim 5, wherein
when a change in the first gear position is requested in a state where the vehicle is not stopped during execution of the automated driving control, the one or more processors reject the change in the first gear position and notify warning information through the notification device.
